(19) United States
(12) Patent Application Publication
(10) Pub. No.: US 2017/0007070 A1
(43) Pub. Date: Jan. 12, 2017

(54) BAKING TRAY WITH INTERCHANGEABLE BAKING INSERTS

(71) Applicant: Jason Tingley, Columbus, OH (US)

(72) Inventor: Jason TINGLEY, Beavercreek, OH (US)

(21) Appl. No.: 15/272,096

(22) Filed: Sep. 21, 2016

Related U.S. Application Data
(63) Continuation of application No. 14/027,276, filed on Sep. 16, 2013, now abandoned.
(60) Provisional application No. 61/701,150, filed on Sep. 14, 2012.

(51) Int. Cl. A47J 37/01

(52) U.S. Cl. CPC A47J 37/01

(57) ABSTRACT

A baking tray that includes a supportive frame having a left portion, a right portion, a front portion, and a rear portion, wherein the front portion includes a front crossbar and wherein the rear portion includes a rear crossbar; and a detachable baking insert adapted to be releasably mounted on the supportive frame that includes a left portion, a right portion, a front portion having an outermost edge, and a rear portion having an outermost edge, wherein the outermost edge of the front portion of the detachable baking insert includes at least one foldable tab formed thereon for releasably engaging the front crossbar, and wherein the outermost edge of the rear portion of the detachable baking insert includes at least one foldable tab formed thereon for releasably engaging the rear crossbar.

### CROSS-REFERENCE TO RELATED APPLICATIONS

This patent application is a continuation of U.S. patent application Ser. No. 14/027,276 filed on Sep. 16, 2106 and entitled “Baking Tray with Interchangeable Baking Inserts”, which claimed the benefit of U.S. Provisional Patent Application Ser. No. 61/701,150 filed on Sep. 14, 2012 and entitled “Baking Tray with Interchangeable Inserts”, the disclosures of which are hereby incorporated by reference herein in their entirety and made part of the present U.S. utility patent application for all purposes.

### BACKGROUND OF INVENTION

The present invention relates generally to an article of manufacture used for industrial baking applications, and more specifically to a baking pan or tray for use in industrial and commercial applications, wherein the baking surface or baking insert portion of the tray may be easily removed and replaced with another baking insert of the same or different design.

Baking pans or trays are commonly used by producers of various baked goods that are supplied to restaurants and grocery stores. Because producers of baked goods often supply large quantities of baked goods to their customers, the trays such goods are baked on are reused many times and are repeatedly subjected to both high thermal and mechanical stresses. Repeated exposure to high temperatures and mechanical stress requires that an industrial baking pan or tray be manufactured from a durable material such as steel or aluminum. Although manufacturing a baking tray from materials such as steel or aluminum does increase the lifespan of the tray, repeated use, re-glazing, or other physical or chemical stressors eventually weakens the metal of the tray and cracks or fractures may appear in the metal surface of the tray. Once a tray has sustained such damage, it is no longer useable and must be discarded. Due to the significant expense of replacing industrial baking trays, additional features may be included to prolong the usable life of these trays. One such feature is a replaceable baking insert/surface that is attached to the body or frame of the tray.

Currently used industrial/commercial baking trays of this nature often include a baking surface that is attached to a frame by welding (permanent) or riveting (permanent/semi-permanent), making removal and replacement of the baking surface difficult and labor-intensive. Removal and replacement of the baking surface may require metalworking methods such as drilling or grinding and may create a food safety hazard by producing metal chips and/or fragments that remain on the tray following the replacement procedure. Because baking surface replacement is labor-intensive and very difficult, trays in need of repair are often shipped to the original tray manufacturer or to a metalworking professional for performance of this work. This aspect of the repair process may add such considerable time and expense that the trays are simply discarded rather than repaired, thereby creating environmental waste and other undesirable consequences. Therefore, there is an ongoing need for an industrial/commercial baking tray that may be quickly, effectively, and inexpensively repaired when the baking insert or baking surface thereof becomes unusable.

### SUMMARY OF THE INVENTION

The following provides a summary of certain exemplary embodiments of the present invention. This summary is not an extensive overview and is not intended to identify key or critical aspects or elements of the present invention or to delineate its scope.

In accordance with one aspect of the present invention, a first baking tray is provided. This baking tray includes a supportive frame, wherein the frame includes a left portion, a right portion, a front portion, and a rear portion, wherein the front portion includes a front crossbar extending between the left portion and right portion, and wherein the rear portion includes a rear crossbar extending between the left portion and the right portion; and a detachable baking insert adapted to be releasably mounted on the supportive frame, wherein the detachable baking insert includes a left portion, a right portion, a front portion having an outermost edge, and a rear portion having an outermost edge, wherein the outermost edge of the front portion of the detachable baking insert includes at least one foldable tab formed thereon prior to the attachment of the baking insert to the frame, and wherein the at least one foldable tab is adapted to releasably engage the front crossbar for securing the front portion of the detachable baking insert thereto, and wherein the outermost edge of the rear portion of the detachable baking insert includes at least one foldable tab formed thereon prior to the attachment of the baking insert to the frame, and wherein the at least one foldable tab is adapted to releasably engage the rear crossbar for securing the rear portion of the detachable baking insert thereto.

In accordance with another aspect of the present invention, a second baking tray is provided. This baking tray includes a supportive frame, wherein the frame includes a left portion, a right portion, a front portion, and a rear portion, wherein the front portion includes a front crossbar extending between the left portion and right portion, and wherein the rear portion includes a rear crossbar extending between the left portion and the right portion; and a detachable baking insert adapted to be releasably mounted on the supportive frame, wherein the detachable baking insert includes a left portion, a right portion, a front portion having an outermost edge, and a rear portion having an outermost edge, wherein the outermost edge of the front portion of the detachable baking insert includes a plurality of foldable tabs formed thereon prior to the attachment of the baking insert to the frame, and wherein each foldable tab is adapted to releasably engage the front crossbar for securing the front portion of the detachable baking insert thereto, and wherein the outermost edge of the rear portion of the detachable baking insert includes a plurality of foldable tabs formed thereon prior to the attachment of the baking insert to the frame, and wherein each foldable tab is adapted to releasably engage the rear crossbar for securing the rear portion of the detachable baking insert thereto.

In yet another aspect of this invention, a baking tray system is provided. This baking tray system includes a supportive frame, wherein the frame includes a left portion, a right portion, a front portion, and a rear portion, wherein the front portion includes a front crossbar extending between the left portion and right portion, wherein the rear portion includes a rear crossbar extending between the left portion and the right portion, and wherein the left and right portions of the frame each include at least one protrusion formed on the uppermost surface thereof, and at least one indentation formed in the bottommost surface thereof, and wherein the protrusions and indentations allow the tray to stack securely with other baking trays having corresponding protrusions and indentations; and a detachable baking insert adapted to be releasably mounted on the supportive frame, wherein the detachable baking insert includes a left portion, a right portion, a front portion having an outermost edge, and a rear portion having an outermost edge, wherein the outermost edge of the front portion of the detachable baking insert includes a plurality of foldable tabs formed thereon prior to the attachment of the baking insert to the frame, and wherein each foldable tab is adapted to releasably engage the front crossbar for securing the front portion of the detachable baking insert thereto, and wherein the outermost edge of the rear portion of the detachable baking insert includes a plurality of foldable tabs formed thereon prior to the attachment of the baking insert to the frame, and wherein each foldable tab is adapted to releasably engage the rear crossbar for securing the rear portion of the detachable baking insert thereto.

Additional features and aspects of the present invention will become apparent to those of ordinary skill in the art upon reading and understanding the following detailed description of the exemplary embodiments. As will be appreciated by the skilled artisan, further embodiments of the invention are possible without departing from the scope and spirit of the invention. Accordingly, the drawings and associated descriptions are to be regarded as illustrative and not restrictive in nature.

### DESCRIPTION OF THE DRAWINGS

The accompanying drawings, which are incorporated into and form a part of the specification, schematically illustrate one or more exemplary embodiments of the invention and, together with the general description given above and detailed description given below, serve to explain the principles of the invention, and wherein:

FIG. 1 is a perspective view of a baking tray in accordance with a first exemplary embodiment of the present invention;

FIG. 2A is a perspective view of the frame component of the baking tray of FIG. 1;

FIG. 2B is a perspective view of the baking insert component of the baking tray of FIG. 1;

FIG. 3 is a perspective view of one end of the baking insert of the baking tray of FIG. 1 showing one of the tabs used to connect the baking insert to the frame;

FIG. 4 is a perspective view of a baking tray in accordance with a second exemplary embodiment of the present invention;

FIG. 5 shows the connecting tool of the present invention being used to attach the baking insert to the frame by crimping the tab shown in FIG. 3; and

FIG. 6 shows the detaching tool of the present invention being used to disconnect the baking insert from the frame by loosening the tab shown in FIG. 3.

### DETAILED DESCRIPTION OF THE INVENTION

Exemplary embodiments of the present invention are now described with reference to the Figures. Although the following detailed description contains many specifics for purposes of illustration, a person of ordinary skill in the art will appreciate that many variations and alterations to the following details are within the scope of the invention. Accordingly, the following embodiments of the invention are set forth without any loss of generality to, and without imposing limitations upon, the claimed invention.

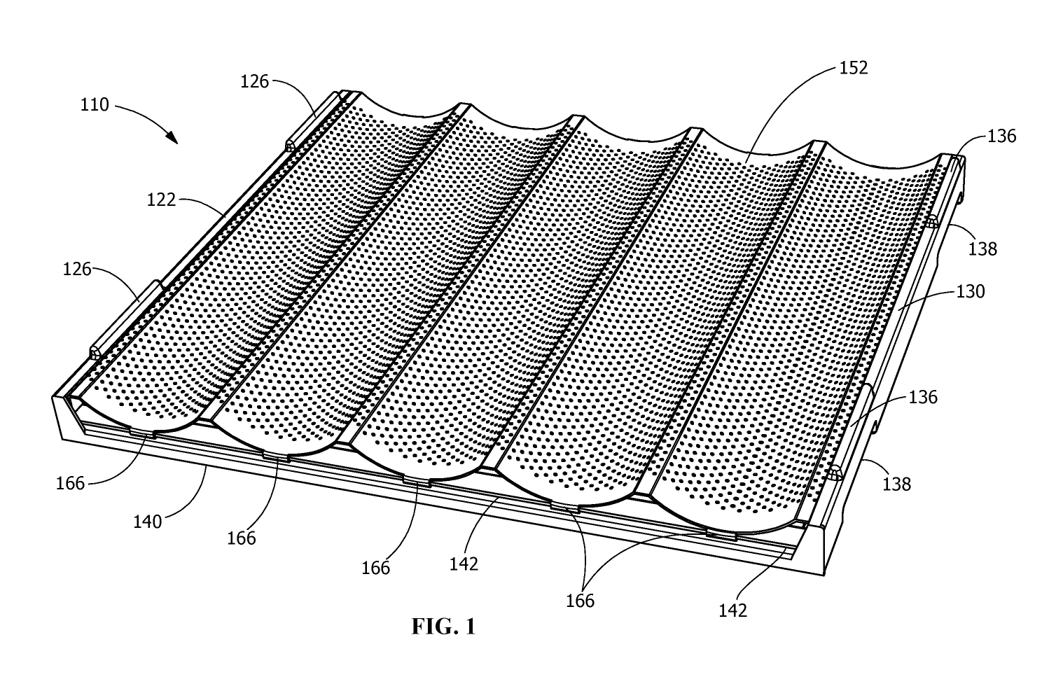

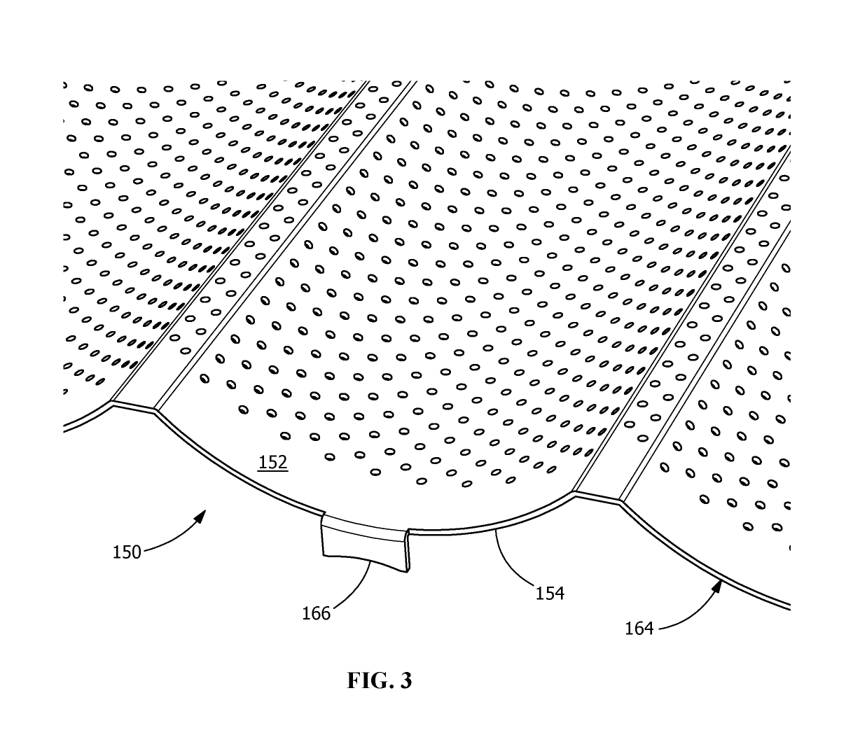

As previously stated, the present invention relates generally to an article of manufacture used for industrial baking applications, and more specifically to a baking pan or tray for use in industrial and commercial applications, wherein the baking surface or baking insert of the tray may be easily removed and replaced with another baking insert of the same or different general design. The present invention may be provided as a system that includes multiple frames; multiple interchangeable baking inserts, at least one tool for connecting the baking inserts to the frame; and at least one tool for detaching the baking inserts from the frame. This system allows baking inserts to be easily installed, removed, or changed from one baking surface type to another in a bakery environment without the use of metalworking or cutting tools that may create dangerous metal shards or metal fragments. The frames and baking inserts included with this invention are typically fabricated using known methodologies. With reference now to FIGS. 1-6, one or more exemplary embodiments of this invention will be described in greater detail.

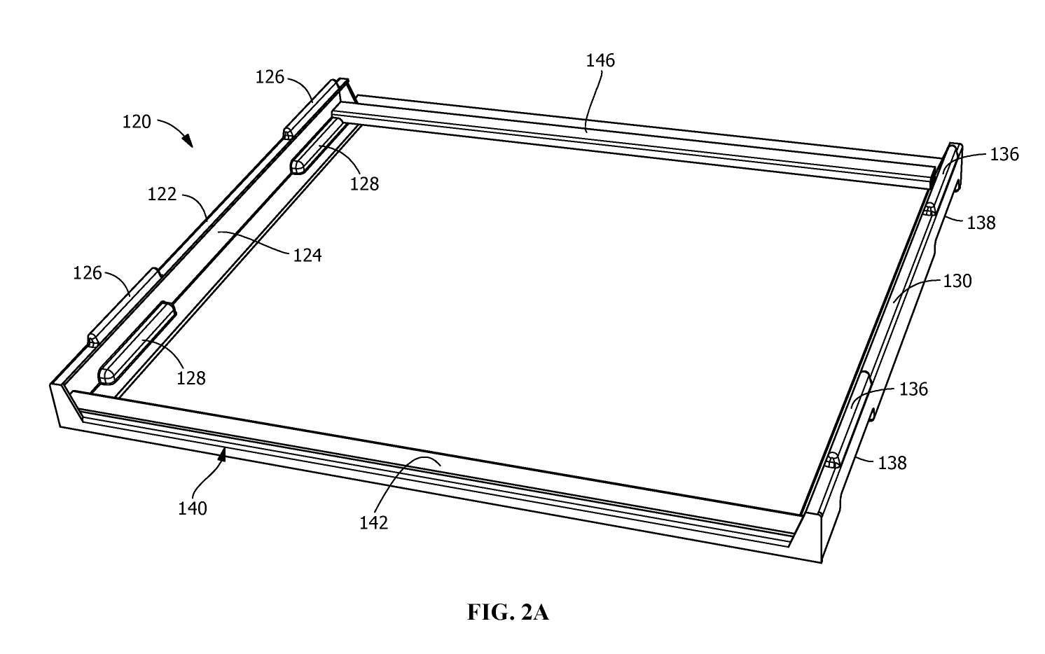

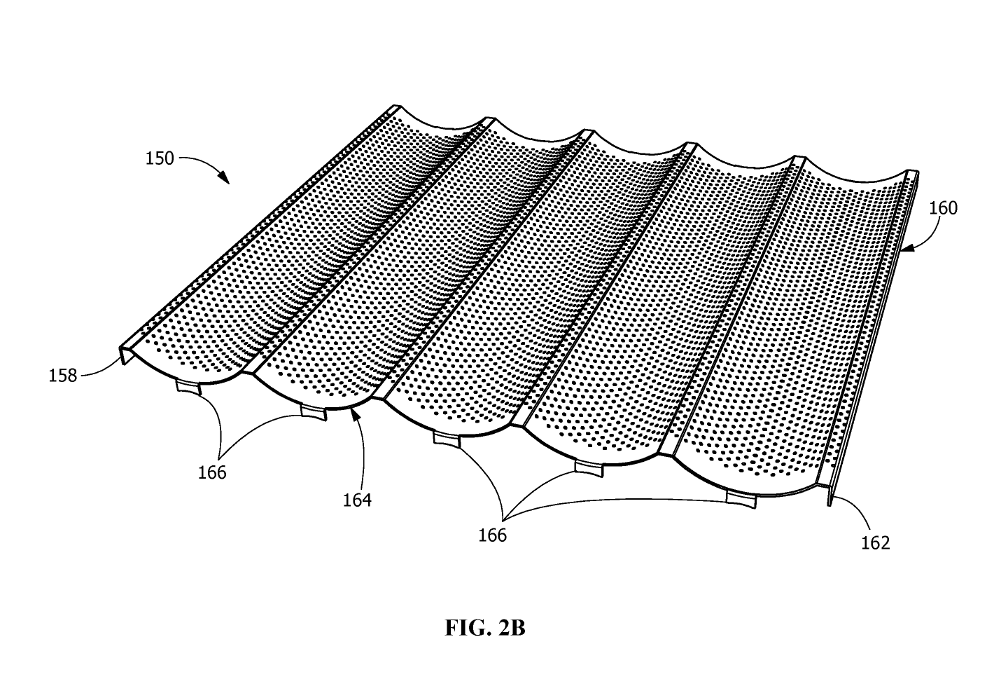

As best shown in FIGS. 1 and 2A-B, a first exemplary baking tray 110 includes metal frame 120 and metal baking insert 150, which is detachably connected to the frame. Frame 120 is generally rectangular in shape and includes left side portion 122, right side portion 130, front portion 140, and rear portion 144. Left side portion 122 further includes channel 124, protrusions 126, and indentations 128. Right side portion 130 further includes channel 132 (not shown), protrusions 136 and indentations 138. Front portion 140 further includes front crossbar 142; and rear portion 144 further includes rear crossbar 146. Baking insert 150, which is also rectangular in shape, includes baking surface 152 and plurality of elongated baking subunits 154 (useful for baguettes or the like), which may be substantially solid, or partially or completely perforated. Baking insert 150 further includes left side portion 156 having a first folded region 158; right side portion 160 having a second folded region 162; front portion 164 having a plurality of tabs 166; and a rear portion 168 also having a plurality of tabs 170 (not shown). As shown in FIG. 1, when baking tray 110 is properly assembled, first folded region 158 is inserted into channel 124; second folded region 162 is inserted into channel 132; tabs 166 are folded or crimped around front crossbar 142; and tabs 170 (not shown) are folded or crimped around rear crossbar 146.

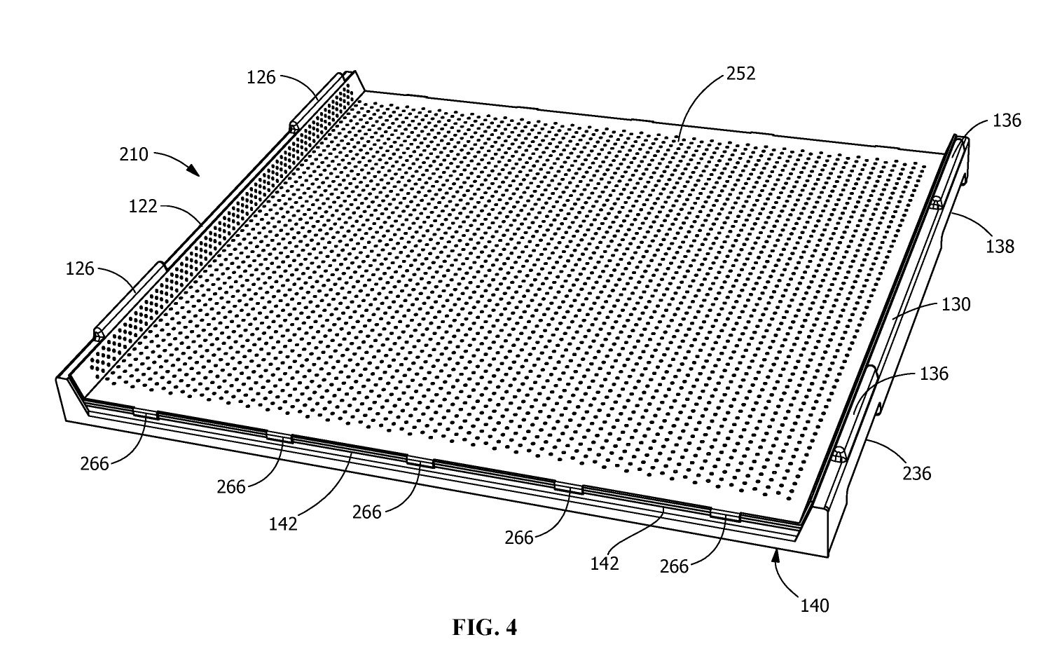

As shown in FIG. 4, a second exemplary baking tray 210 includes metal frame 120 and metal baking insert 250, which although different in configuration, is mounted on and attached to metal frame 120 in the same manner as the previously described embodiment. Frame 120 includes left side portion 122, right side portion 130, front portion 140, and rear portion 144. Left side portion 122 further includes channel 124, protrusions 126, and indentations 128. Right side portion 130 further includes channel 132 (not shown), protrusions 136 and indentations 138. Front portion 140 further includes front crossbar 142, and rear portion 144 further includes rear crossbar 146. Baking insert 250 includes baking surface 252, which may be substantially solid or partially or completely perforated. Baking insert 250 further includes left side portion 256 having a first folded region 258; right side portion 260 having a second folded region 262; front portion 264 having a plurality of tabs 266; and a rear portion 268 also having a plurality of tabs 270 (not shown). As shown in FIG. 4, when baking tray 210 is properly assembled, first folded region 258 is inserted into channel 124; second folded region 262 is inserted into channel 132; tabs 266 are folded or crimped around front crossbar 142; and tabs 170 (not shown) are folded or crimped around rear crossbar 146.

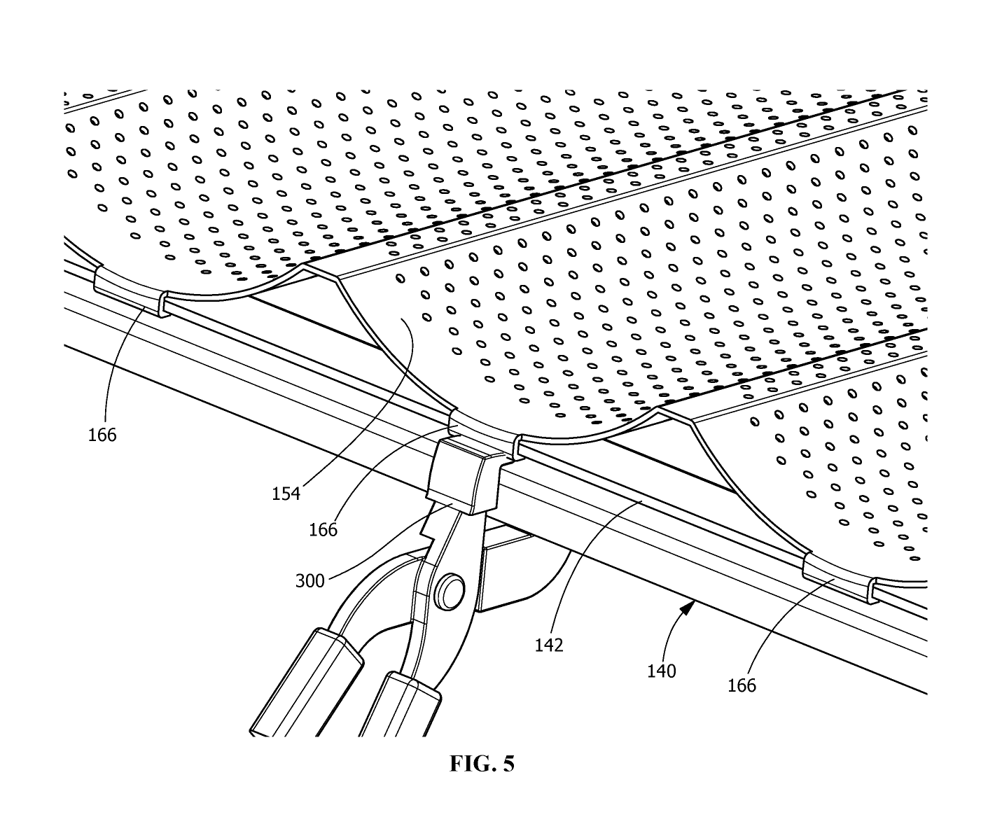

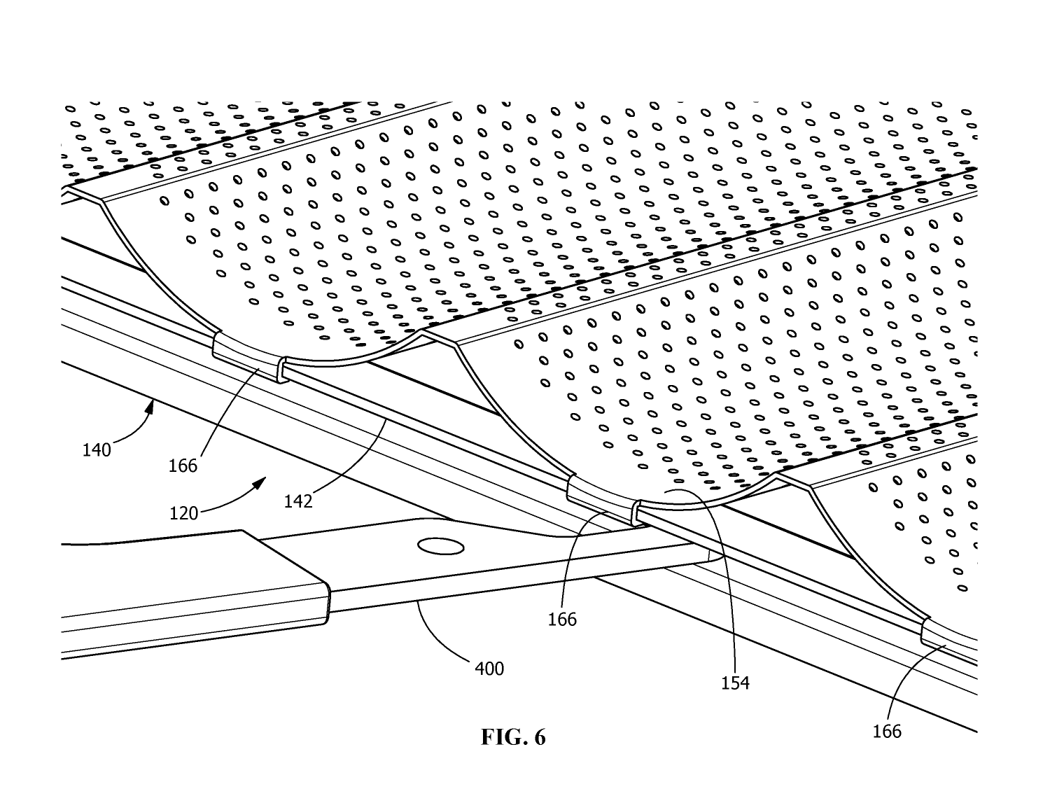

With reference to FIGS. 5 and 6, tabs 166 and 266 are typically attached to the crossbars of frame 120 using a crimping tool that has been designed specifically for use with the baking trays of the present invention, or that has been adapted for use with these trays. Similarly, tabs 166 and 266 are released from crossbars 142 and 146 using a prying or releasing tool that has been either designed specifically for use with the baking trays of the present invention, or that has been adapted for use with these trays. Removing the baking insert in this manner does not damage frame 120 and thus allows frame 120 to be used and re-used with various baking inserts that are replacements for damaged or worn baking inserts or that are intended to be used to create other types of baked goods. The baking trays of the present invention are also intended to be stackable, and protrusions 126 and 136 and indentations 128 and 138 are included on frame 120 to provide this feature. The indentations on the bottom of a tray receive the protrusions on the top of another tray and together these structures allow the baking trays of this invention to be securely stacked on top of one another.

While the present invention has been illustrated by the description of exemplary embodiments thereof, and while the embodiments have been described in certain detail, it is not the intention of the Applicant to restrict or in any way limit the scope of the appended claims to such detail. Additional advantages and modifications will readily appear to those skilled in the art. Therefore, the invention in its broader aspects is not limited to any of the specific details, representative devices and methods, and/or illustrative examples shown and described. Accordingly, departures may be made from such details without departing from the spirit or scope of the applicant's general inventive concept.

What is claimed:

1. A baking tray, comprising:
(a) a supportive frame,
(i) wherein the frame includes a left portion, a right portion, a front portion, and a rear portion,
(ii) wherein the front portion includes a front crossbar extending between the left portion and right portion, and
(iii) wherein the rear portion includes a rear crossbar extending between the left portion and the right portion; and
(b) a detachable baking insert adapted to be releasably mounted on the supportive frame,
(i) wherein the detachable baking insert includes a left portion, a right portion, a front portion having an outermost edge, and a rear portion having an outermost edge,
(ii) wherein the outermost edge of the front portion of the detachable baking insert includes at least one foldable tab formed thereon prior to the attachment of the baking insert to the frame, and wherein the at least one foldable tab is adapted to releasably engage the front crossbar for securing the front portion of the detachable baking insert thereto, and
(iii) wherein the outermost edge of the rear portion of the detachable baking insert includes at least one foldable tab formed thereon prior to the attachment of the baking insert to the frame, and wherein the at least one foldable tab is adapted to releasably engage the rear crossbar for securing the rear portion of the detachable baking insert thereto.

2. The baking tray of claim 1, wherein the left and right portions of the frame each include a channel formed lengthwise therein, and wherein the left and right portions of the baking insert each include a folded region, the geometry of which corresponds to the channels formed lengthwise in the frame.

3. The baking tray of claim 1, wherein the left and right portions of the frame each include at least one protrusion formed on the uppermost surface thereof, and at least one indentation formed in the bottommost surface thereof, and wherein the protrusions and indentations allow the tray to stack securely with other baking trays having corresponding protrusions and indentations.

4. The baking tray of claim 1 wherein the baking insert further includes a single baking surface formed thereon.

5. The baking tray of claim 1, wherein the baking insert further includes a plurality of individual baking subunits formed therein.

6. The baking tray of claim 1, wherein the baking insert is perforated. The baking tray of claim 1, wherein the baking insert is substantially solid.

8. A baking tray, comprising:
(a) a supportive frame,
(i) wherein the frame includes a left portion, a right portion, a front portion, and a rear portion,
(ii) wherein the front portion includes a front crossbar extending between the left portion and right portion, and
(iii) wherein the rear portion includes a rear crossbar extending between the left portion and the right portion; and
(b) a detachable baking insert adapted to be releasably mounted on the supportive frame,
(i) wherein the detachable baking insert includes a left portion, a right portion, a front portion having an outermost edge, and a rear portion having an outermost edge,
(ii) wherein the outermost edge of the front portion of the detachable baking insert includes a plurality of foldable tabs formed thereon prior to the attachment of the baking insert to the frame, and wherein each foldable tab is adapted to releasably engage the front crossbar for securing the front portion of the detachable baking insert thereto, and
(iii) wherein the outermost edge of the rear portion of the detachable baking insert includes a plurality of foldable tabs formed thereon prior to the attachment of the baking insert to the frame, and wherein each foldable tab is adapted to releasably engage the rear crossbar for securing the rear portion of the detachable baking insert thereto.

9. The baking tray of claim 8, wherein the left and right portions of the frame each include a channel formed lengthwise therein, and wherein the left and right portions of the baking insert each include a folded region, the geometry of which corresponds to the channels formed lengthwise in the frame.

10. The baking tray of claim 8, wherein the left and right portions of the frame each include at least one protrusion formed on the uppermost surface thereof, and at least one indentation formed in the bottommost surface thereof, and wherein the protrusions and indentations allow the tray to stack securely with other baking trays having corresponding protrusions and indentations.

11. The baking tray of claim 8 wherein the baking insert further includes a single baking surface formed thereon.

12. The baking tray of claim 8, wherein the baking insert further includes a plurality of individual baking subunits formed therein.

13. The baking tray of claim 8, wherein the baking insert is perforated.

14. The baking tray of claim 8, wherein the baking insert is substantially solid.

15. A baking tray, comprising:
(a) a supportive frame,
(i) wherein the frame includes a left portion, a right portion, a front portion, and a rear portion,
(ii) wherein the front portion includes a front crossbar extending between the left portion and right portion,
(iii) wherein the rear portion includes a rear crossbar extending between the left portion and the right portion, and
(iv) wherein the left and right portions of the frame each include at least one protrusion formed on the uppermost surface thereof, and at least one indentation formed in the bottommost surface thereof, and wherein the protrusions and indentations allow the tray to stack securely with other baking trays having corresponding protrusions and indentations; and
(b) a detachable baking insert adapted to be releasably mounted on the supportive frame,
(i) wherein the detachable baking insert includes a left portion, a right portion, a front portion having an outermost edge, and a rear portion having an outermost edge,
(ii) wherein the outermost edge of the front portion of the detachable baking insert includes a plurality of foldable tabs formed thereon prior to the attachment of the baking insert to the frame, and wherein each foldable tab is adapted to releasably engage the front crossbar for securing the front portion of the detachable baking insert thereto, and
(iii) wherein the outermost edge of the rear portion of the detachable baking insert includes a plurality of foldable tabs formed thereon prior to the attachment of the baking insert to the frame, and wherein each foldable tab is adapted to releasably engage the rear crossbar for securing the rear portion of the detachable baking insert thereto.

16. The baking tray of claim 15, wherein the left and right portions of the frame each include a channel formed lengthwise therein, and wherein the left and right portions of the baking insert each include a folded region, the geometry of which corresponds to the channels formed lengthwise in the frame.

17. The baking tray of claim 15 wherein the baking insert further includes a single baking surface formed thereon.

18. The baking tray of claim 15, wherein the baking insert further includes a plurality of individual baking subunits formed therein.

19. The baking tray of claim 15, wherein the baking insert is perforated.

20. The baking tray of claim 15, wherein the baking insert is substantially solid.
